(19) United States
(12) Patent Application Publication
(10) Pub. No.: US 2025/0296210 A1
(43) Pub. Date: Sep. 25, 2025

(54) DISPLAY DEVICE, ACQUISITION SYSTEM, PROCESSING METHOD, AND STORAGE MEDIUM

(71) Applicant: KABUSHIKI KAISHA TOSHIBA, Tokyo (JP)

(72) Inventors: Sumire NISHIJIMA, Kodaira Tokyo (JP); Hiroki SHINAGAWA, Yokohama Kanagawa (JP); Yukino MASUI, Yokohama Kanagawa (JP); Ren YAMASHITA, Yokohama Kanagawa (JP); Takanori YOSHII, Kawasaki Kanagawa (JP); Kyotaro HAYASHI, Yokohama Kanagawa (JP); Hiroaki NAKAMURA, Kawasaki Kanagawa (JP); Yoshiyuki HIRAHARA, Mishima Shizuoka (JP); Akiko KASE, Yokohama Kanagawa (JP); Masamitsu FUKUDA, Yokohama Kanagawa (JP); Takafumi KOZAKAI, Ota Tokyo (JP); Yasuo NAMIOKA, Nerima Tokyo (JP)

(21) Appl. No.: 19/059,985

(22) Filed: Feb. 21, 2025

(30) Foreign Application Priority Data
Mar. 21, 2024 (JP) 2024-045204

(51) Int. Cl. B25B 23/142; B25B 23/15; G06F 3/01; G06F 3/03; G06T 19/00; H04N 13/344; H04N 13/366

(52) U.S. Cl. CPC B25B 23/1425; B25B 23/15; G06F 3/011; G06F 3/0312; G06T 19/006; H04N 13/344; H04N 13/366

(57) ABSTRACT

According to one embodiment, a display device is configured to display a virtual object to overlap a real space. The display device is configured to acquire a position and a direction of the display device. The display device is configured to display a first virtual object indicating a permissible task range, the permissible task range being set using the position and the direction. The display device is configured to set a task position at a prescribed position for a fastening location of an article present in the real space. The display device is configured to determine whether or not the task position is within the permissible task range, and output a first alert when the task position is outside the permissible task range.

### CROSS-REFERENCE TO RELATED APPLICATIONS

This application is based upon and claims the benefit of priority from Japanese Patent Application No. 2024-045204, filed on Mar. 21, 2024; the entire contents of which are incorporated herein by reference.

### FIELD

Embodiments of the invention generally relate to a display device, an acquisition system, a processing method, and a storage medium.

### BACKGROUND

Conventionally, a display device that can display a virtual space to overlap real space has been used to increase the efficiency of a task. The display device can provide various information to a worker. The worker can perform the task more efficiently by referring to the displayed information. Technology of the display device that allows the task to be performed more safely is desirable.

### BRIEF DESCRIPTION OF THE DRAWINGS

FIG. 1 is a schematic view illustrating a display device according to an embodiment;

FIG. 2 is a schematic view illustrating an article that is a task object;

FIG. 3 is a schematic view for describing a display example according to the display device;

FIG. 4 is a schematic view for describing a display example according to the display device;

FIGS. 5A to 5C are schematic views illustrating a task position;

FIG. 6A is a schematic view for describing processing according to the display device according to the embodiment, and

FIG. 6B is a schematic view showing a display example according to the display device according to the embodiment;

FIG. 7 is a schematic view showing a display example according to the display device according to the embodiment;

FIG. 8 is a schematic view showing a display example according to the display device according to the embodiment;

FIG. 9 is a schematic view showing a display example according to the display device according to the embodiment;

FIGS. 10A and 10B are schematic views showing display examples according to the display device according to the embodiment;

FIG. 11 is a schematic view showing an example of a tool;

FIG. 12 is a schematic view showing a task;

FIG. 13 is a schematic view for describing calculation methods according to a first embodiment;

FIGS. 14A and 14B are schematic views for describing the calculation methods according to the first embodiment;

FIG. 15 is a schematic view for describing the calculation methods according to the first embodiment;

FIG. 16 is a schematic view for describing the calculation methods according to the first embodiment;

FIG. 17 is a schematic view showing a display example according to the display device according to the embodiment;

FIG. 18 is a schematic view showing a specific example of a virtual object;

FIG. 19 is a schematic view showing a display example according to the display device according to the embodiment;

FIG. 20 is a schematic view showing a display example according to the display device according to the embodiment;

FIG. 21 is a schematic view showing a display example according to the display device according to the embodiment;

FIG. 22 is a schematic view showing a display example according to the display device according to the embodiment;

FIG. 23 is a schematic view showing a display example according to the display device according to the embodiment;

FIG. 24 is a flowchart showing a processing method according to the embodiment;

FIG. 25 is a flowchart showing a confirmation method according to the embodiment;

FIG. 26 is a schematic view showing a configuration of an acquisition system according to the embodiment;

FIG. 27 is a schematic view for describing processing in a registration mode of a permissible task range; and

FIG. 28 is a schematic view showing a hardware configuration.

### DETAILED DESCRIPTION

According to one embodiment, a display device is configured to display a virtual object to overlap a real space. The display device is configured to acquire a position and a direction of the display device. The display device is configured to display a first virtual object indicating a permissible task range, the permissible task range being set using the position and the direction. The display device is configured to set a task position at a prescribed position for a fastening location of an article present in the real space. The display device is configured to determine whether or not the task position is within the permissible task range, and output a first alert when the task position is outside the permissible task range.

Embodiments of the invention will now be described with reference to the drawings. The drawings are schematic or conceptual; and the relationships between the thicknesses and widths of portions, the proportions of sizes between portions, etc., are not necessarily the same as the actual values thereof. The dimensions and/or the proportions may be illustrated differently between the drawings, even in the case where the same portion is illustrated. In the drawings and the specification of the application, components similar to those described thereinabove are marked with like reference numerals, and a detailed description is omitted as appropriate.

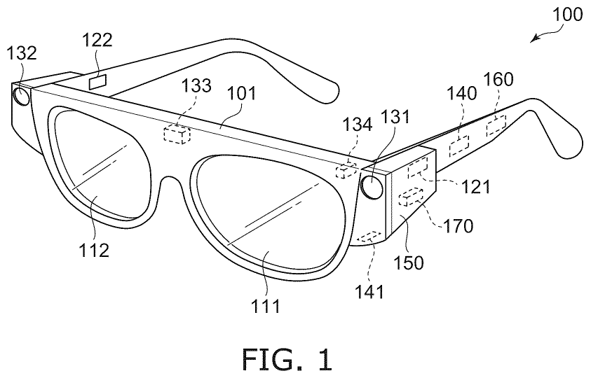

FIG. 1 is a schematic view illustrating a display device according to an embodiment.

The embodiment of the invention relates to a display device. For example, as shown in FIG. 1, the display device 100 according to the embodiment includes a frame 101, a lens 111, a lens 112, a projection device 121, a projection device 122, an image camera 131, a depth camera 132, a light source 133, an eye tracking camera 134, a sensor 140, a microphone 141, a processing device 150, a battery 160, and a storage device 170.

In the illustrated example, the display device 100 is a binocular head mounted display. Two lenses, i.e., the lens 111 and the lens 112, are fit into the frame 101. The projection device 121 and the projection device 122 respectively project information onto the lenses 111 and 112.

The projection device 121 and the projection device 122 display a recognition result of a body of a worker (a wearer), a virtual object, etc., on the lenses 111 and 112. Only one of the projection device 121 or the projection device 122 may be included; and information may be displayed on only one of the lens 111 or the lens 112.

The lens 111 and the lens 112 are light-transmissive. The worker can visually recognize reality via the lenses 111 and 112. Also, the worker can visually recognize the information projected onto the lenses 111 and 112 by the projection devices 121 and 122. Information (virtual space) is displayed to overlap real space by being projected by the projection devices 121 and 122.

The image camera 131 detects visible light and obtains a two-dimensional image. The depth camera 132 irradiates infrared light and obtains a depth image based on the reflected infrared light. The light source 133 irradiates light (e.g., infrared light) toward an eyeball of the wearer. The eye tracking camera 134 detects light reflected by the eyeball of the wearer. The sensor 140 is a six-axis detection sensor and is configured to detect angular velocities in three axes and accelerations in three axes. The microphone 141 accepts an audio input.

The processing device 150 controls components of the display device 100. For example, the processing device 150 controls the projection devices 121 and 122 and causes the projection devices 121 and 122 to display information on the lenses 111 and 112. Hereinafter, the processing device 150 using the projection devices 121 and 122 to display information on the lenses 111 and 112 also is called simply “the processing device displaying information”. The processing device 150 also detects movement of the visual field based on a detection result of the sensor 140. The processing device 150 modifies the display by the projection devices 121 and 122 according to the movement of the visual field.

The processing device 150 also is configured to perform various processing by using data obtained from the image camera 131 and the depth camera 132, data of the storage device 170, etc. For example, the processing device 150 recognizes a preset object based on the image obtained by the image camera 131. The processing device 150 recognizes the surface shape of the object based on the image obtained by the depth camera 132. The processing device 150 calculates the viewpoint and line of sight of the eyes of the worker based on the detection result obtained by the eye tracking camera 134.

The battery 160 supplies power necessary for the operations to the components of the display device 100. The storage device 170 stores data necessary for the processing of the processing device 150, data obtained by the processing of the processing device 150, etc. The storage device 170 may be located outside the display device 100, and may communicate with the processing device 150.

The display device is not limited to the illustrated example, and may be a monocular head mounted display. The display device may be an eyeglasses-type as illustrated, or may be a helmet-type.

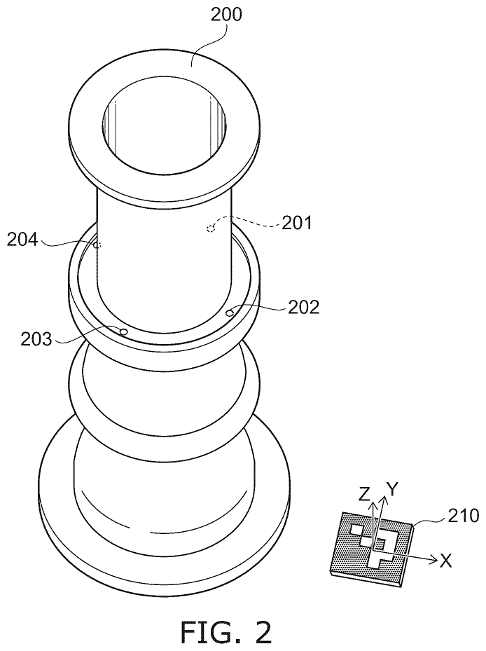

FIG. 2 is a schematic view illustrating an article that is a task object.

For example, a task is performed on the article 200 shown in FIG. 2. The article 200 is a hollow tubular member, and includes fastening locations 201 to 204. In the task, a tool is used to fasten a fastener such as a screw or the like to the article. Or, a tool is used to loosen a screw fastened to the article. The article is a part, a unit, a semifinished product, etc., for making a product. The tool is a wrench, a screw driver, etc. Herein, an example is mainly described in which embodiments of the invention are applied to a fastening task of tightening a screw.

The worker uses an extension bar and a wrench to turn screws at the fastening locations 201 to 204. A marker 210 is located proximate to the task object. In the illustrated example, the marker 210 is an AR marker. As described below, the marker 210 is provided for setting the origin of the three-dimensional coordinate system. Instead of the AR marker, a one-dimensional code (a barcode), a two-dimensional code (a QR code (registered trademark)), etc., may be used as the marker 210. Or, instead of a marker, the origin may be indicated by a hand gesture. The processing device 150 sets the three-dimensional coordinate system by using multiple points indicated by the hand gesture as a reference. For example, the three-dimensional coordinate system is represented by an X-axis direction (a first axial direction), a Y-axis direction (a second axial direction), and a Z-axis direction which are orthogonal to each other.

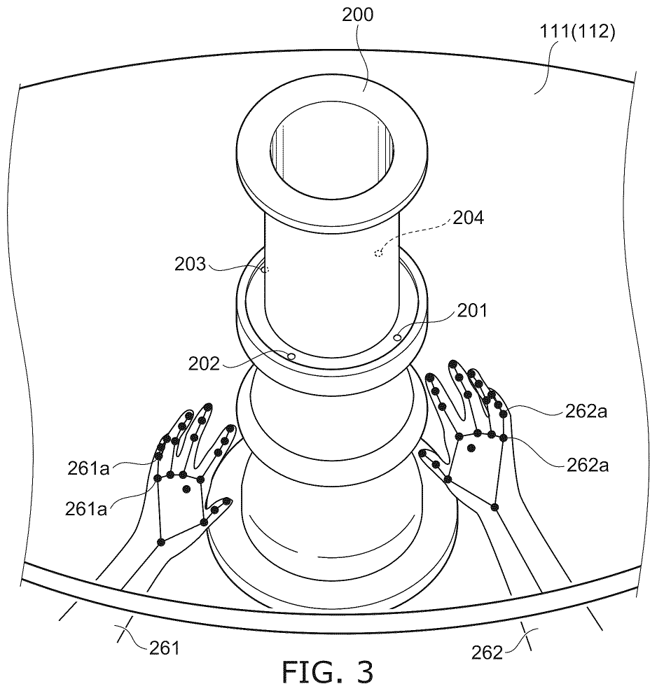

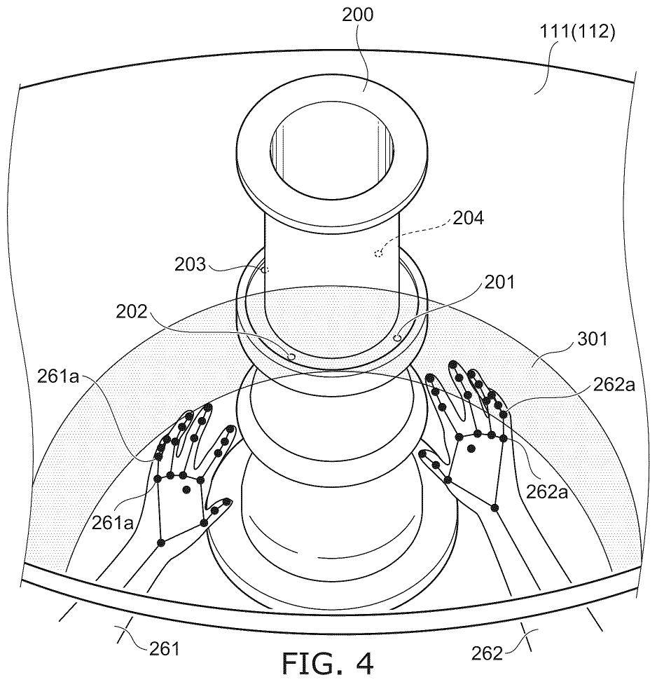

FIGS. 3 and 4 are schematic views for describing display examples according to the display device.

When the fastening task is started, the image camera 131 and the depth camera 132 image the marker 210. The processing device 150 recognizes the marker 210 based on the captured image. The processing device 150 sets the three-dimensional coordinate system by using the position of the marker 210 as a reference.

The object for the setting is arbitrary as long as the three-dimensional coordinate system can be set. Herein, an example is described in which the three-dimensional coordinate system is set using the marker 210. When starting the task, the image camera 131 and the depth camera 132 image the marker 210. The processing device 150 recognizes the marker 210 based on the captured image. The processing device 150 sets the origin of the virtual space by using the position and orientation of the marker 210 as a reference. The three-dimensional coordinate system is defined based on the origin. By setting the origin referenced to an object present in real space, a virtual object can be displayed to correspond to the object in real space.

The image camera 131 and the depth camera 132 image the article 200, the left hand of the worker, and the right hand of the worker. The processing device 150 recognizes the left hand and the right hand based on the captured image. When a left hand 261 and a right hand 262 are recognized, the processing device 150 measures the positions of the hands. Specifically, each hand includes multiple joints such as a DIP joint, a PIP joint, an MP joint, a CM joint, etc. The position of any of these joints is used as the position of the hand. The centroid position of multiple joints may be used as the position of the hand. Or, the center position of the entire hand may be used as the position of the hand. The processing device 150 performs hand tracking in which the positions of the hands are repeatedly measured.

The processing device 150 causes the projection devices 121 and 122 to display the recognition result on the lenses 111 and 112. Hereinafter, the processing device using the projection device to display information on the lens also is called simply “the processing device displaying information”.

For example, as shown in FIG. 3, the processing device 150 displays the recognition result of the left hand 261 and the recognition result of the right hand 262 to overlap the hands in real space. In the illustrated example, multiple virtual objects 261a and multiple virtual objects 262a are displayed as the recognition results of the left and right hands 261 and 262. The multiple virtual objects 261a respectively indicate multiple joints of the left hand 261. The multiple virtual objects 262a respectively indicate multiple joints of the right hand 262. Virtual objects that respectively indicate the surface shape of the left hand 261 and the surface shape of the right hand 262 may be displayed instead of the joints.

The processing device 150 also calculates the position and direction of the display device 100. As an example, the processing device 150 uses a spatial mapping function to calculate the position and direction of the display device 100. More specifically, the depth camera 132 measures distances to objects in the surrounding area of the display device 100. The surface information of the objects in the surrounding area is obtained from the measurement result (the depth image) of the depth camera 132. The surface information includes the positions and directions of the surfaces of the objects. For example, the surface of each object is represented by multiple meshes; and the position and direction of each mesh are calculated. Based on the surface information, the processing device 150 calculates the relative position and direction of the display device 100 with respect to the surfaces of the objects in the surrounding area. When the marker 210 is recognized, the positions of the surfaces also are represented using the three-dimensional coordinate system having the marker 210 as the origin. The position and direction of the display device 100 in the three-dimensional coordinate system are calculated based on the positional relationship between the display device 100 and the surfaces of the objects. Herein, the direction of the display device 100 refers to the direction of the front of the display device 100. For example, when the worker wears the display device 100, the direction of the display device 100 is parallel to the frontward direction of the face of the worker.

The spatial mapping is repeatedly performed at a prescribed interval. The surface information of the objects in the surrounding area is obtained each time the spatial mapping is performed. The processing device 150 calculates the changes of the positions and directions of the surfaces between the result of the latest spatial mapping and the result of the directly-previous spatial mapping. In circumstances in which the objects in the surrounding area do not move, changes of the positions of the surfaces and changes of the directions of the surfaces correspond to a change of the position of the display device 100 and a change of the direction of the display device 100. The processing device 150 calculates the change amounts of the position and direction of the display device 100 based on the changes of the positions of the surfaces and the changes of the directions of the surfaces. The detection result of the sensor 140 also may be used to calculate the change amounts of the position and direction of the display device 100. The processing device 150 updates the position and direction of the display device 100 based on the obtained change amount. Instead of spatial mapping, existing positioning methods may be used to acquire the position and direction of the display device 100.

When the position and direction of the display device 100 are acquired by one of the methods, the processing device 150 uses the acquired position and direction to set a permissible task range. The permissible task range is a range in which the wearer of the display device 100 can safely perform the task. When the permissible task range is set, the processing device 150 may display a virtual object 301 (a first virtual object) indicating the permissible task range as shown in FIG. 4. Based on the display of the virtual object 301, the worker can visually recognize the range in which the task can be performed safely.

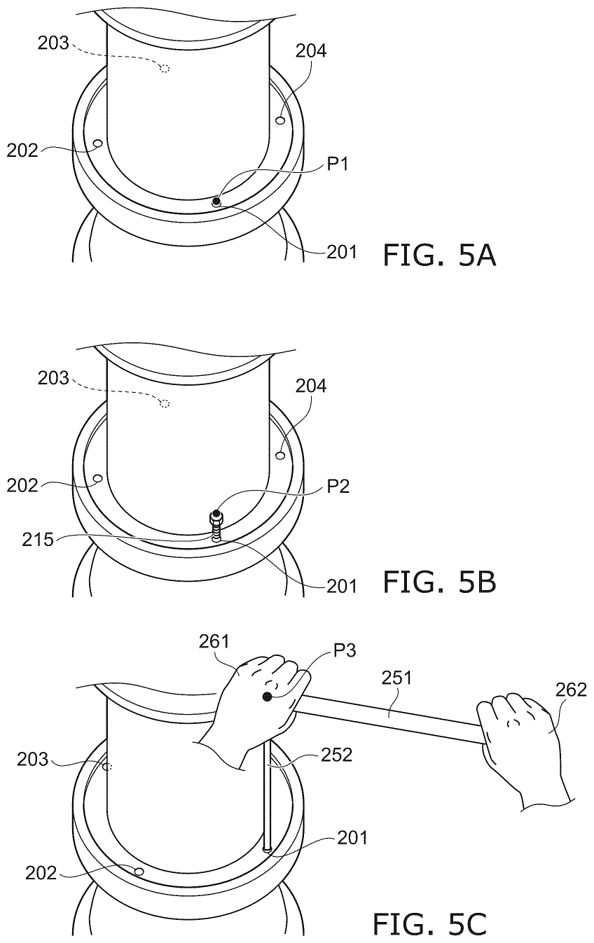

FIGS. 5A to 5C are schematic views illustrating a task position.

The processing device 150 acquires the task position. The task position is set to a prescribed position with respect to a fastening location of the article 200. The positional relationship of the task position for the fastening location is appropriately set according to the task being performed, the ease of the setting of the task position, etc. For example, the positions of the fastening locations 201 to 204 are preregistered in a database. The positions of the fastening locations 201 to 204 are represented using the three-dimensional coordinate system based on the marker 210. In such a case, as shown in FIG. 5A, the processing device 150 can use a position P1 of the fastening location 201 as the task position.

In addition to the positions of the fastening locations 201 to 204, when data of the fastener to be used is preregistered, the processing device 150 may use a position P2 as the task position as shown in FIG. 5B. The position P2 is positioned at the screw head of a screw 215, and is separated from the fastening location 201 by the length of the screw 215 in the direction of the screw hole.

In addition to the positions of the fastening locations 201 to 204, data of the tool to be used may be preregistered. For example, when a wrench 251 and an extension bar 252 are used in the task as shown in FIG. 5C, the processing device 150 may use a position P3 as the task position as shown in FIG. 5C. The position P3 is separated from the fastening location 201 by the length of the tool (the extension bar 252) in the direction of the screw hole. The position P3 is the position at which the hand is to be placed during the task. When the screw is turned with the wrench 251 without using the extension bar 252, the position P3 may be the same as the position P2.

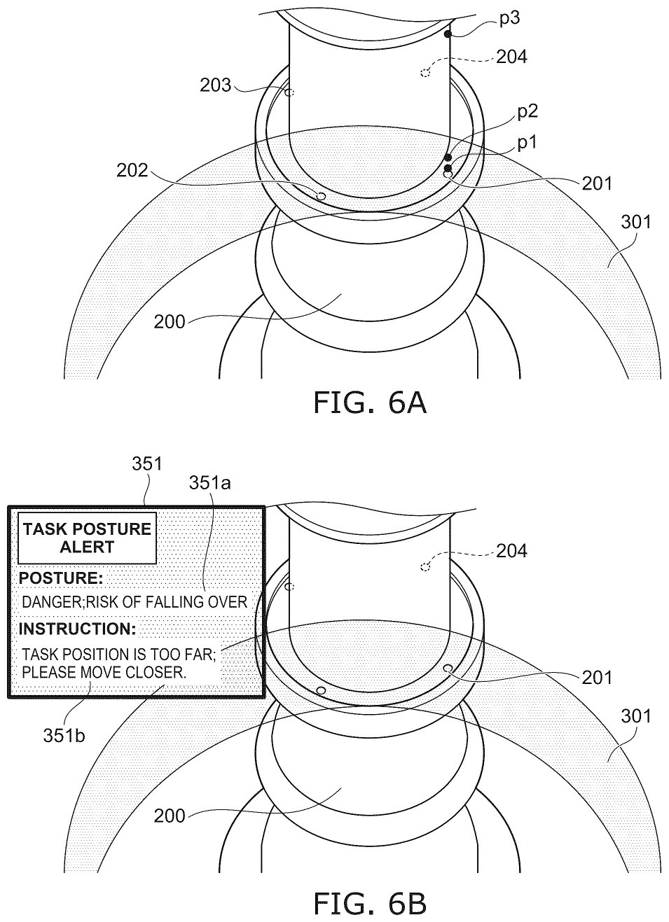

FIG. 6A is a schematic view for describing processing according to the display device according to the embodiment. FIG. 6B is a schematic view showing a display example according to the display device according to the embodiment.

When the task position is set, the processing device 150 determines whether or not the task position is within the permissible task range. In the example shown in FIG. 6A, the positions P1 to P3 each are positioned outside the permissible task range indicated by the virtual object 301. Therefore, the task position is determined not to be within the permissible task range.

As shown in FIG. 6B, the processing device 150 outputs an alert 351 (a first alert) indicating danger of the task. The alert 351 includes messages 351a and 351b. The message 351a indicates the danger when the task is performed at the current worker position. The message 351b is an instruction to the worker. The worker approaches the fastening location 201 according to the output of the alert 351.

Instead of a message such as the alert 351, a sound, light, a vibration, etc., may be output as the alert. For example, the processing device 150 may output a voice indicating danger and a voice that instructs the worker. A sound, light, a vibration, etc., also may be output in addition to a message.

The permissible task range with respect to the position and direction of the display device 100 is preregistered for each worker. The processing device 150 refers to the permissible task range of the worker (the wearer of the display device 100). The processing device 150 sets the permissible task range by using the acquired position and direction of the display device 100 as a reference.

Or, the permissible task range may be set using physique data of the worker. For example, the distance to the farthest hand within the range in which the task can be safely performed with respect to the position and direction of the display device 100 is preregistered as the physique data. The distance is dependent on the arm length, the neck length, the shoulder width, etc., of the wearer. The processing device 150 refers to the distance registered in the physique data of the wearer. The processing device 150 sets the range to the distance referenced to the position and direction of the display device 100 as the permissible task range.

More detailed physique data such as the arm length from the shoulder to the hand, the shoulder width, the neck length, etc., may be registered. In such a case, the processing device 150 can calculate the position of the shoulder by using the position and direction of the display device 100, the neck length, and the shoulder width. The processing device 150 uses, as the permissible task range, a range set based on the arm length referenced to the shoulder position. It is difficult for the worker to move the tool in a state in which the arms are extended straight. It is therefore favorable to use a value of the arm length multiplied by a prescribed ratio as the distance from the display device 100 to the outer edge of the permissible task range.

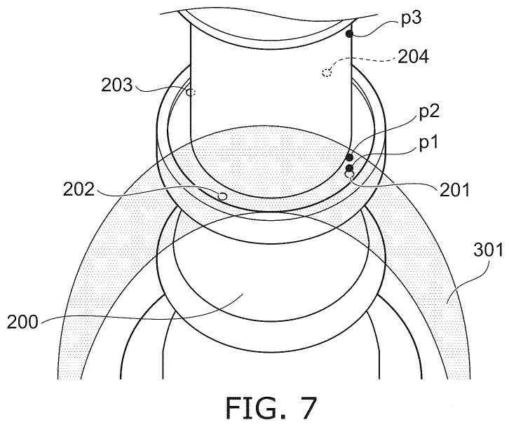

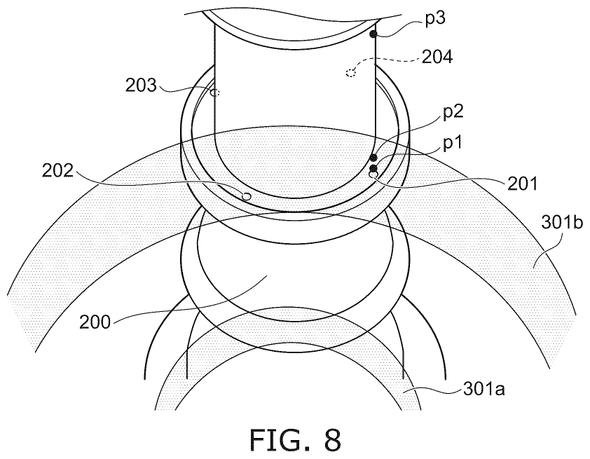

FIGS. 7 and 8 are schematic views showing display examples according to the display device according to the embodiment.

As shown in FIG. 3, the shape of the permissible task range (the virtual object 301) may be simply a circle or a sphere. The display device 100 is at the center of the circle or sphere; and the radius of the circle or sphere is the preregistered distance between the display device 100 and the hand.

Or, as shown in FIG. 7, the shape of the permissible task range may be elliptical. This is because the worker performs the task most easily in the direction in which the display device 100 faces (the front). In such a case, the dimension of the permissible task range in the direction of the display device 100 (the frontward direction of the worker) is greater than the dimension of the permissible task range in an orthogonal direction that is orthogonal to the direction of the display device 100. For example, the processing device 150 uses the preregistered distance between the display device 100 and the hand as the dimension of the permissible task range in the direction of the display device 100. The processing device 150 uses the value obtained by multiplying the distance by a prescribed ratio as the dimension of the permissible task range in the orthogonal direction.

Or, the shape of the permissible task range may be a two-dimensional or three-dimensional torus. In other words, a range that is too close to the worker may not be within the permissible task range. This is because the worker's arms are not easily moved to positions that are too proximate to the worker, and so the task is difficult. In such a case, the permissible task range includes two types of outer edges. For example, virtual objects 301a and 301b are displayed as shown in FIG. 8. The virtual object 301a indicates the outer edge at the inner side of the permissible task range. The virtual object 301b indicates the outer edge at the outer side of the permissible task range. The distance between the display device 100 and the virtual object 301b is greater than the distance between the display device 100 and the virtual object 301a. The virtual object 301a indicates the limit of the range in which the task can be performed safely at a position proximate to the worker. The virtual object 301b indicates the limit of the range in which the task can be performed safely at a position separated from the worker.

Advantages of the embodiment will now be described.

It is desirable to safely perform the task. For example, when the position of the worker and the position of the fastening location are separated, it is necessary for the worker's arm to be extended to the limit. It is also necessary to bend forward to bring the hand closer to the fastening location. If the task is performed in such an improper posture, it is possible to be injured by falling over, or to hurt one's joints.

According to the embodiment, when the position and direction of the display device 100 are acquired, the permissible task range is set using the position and direction. The task position is set to a prescribed position with respect to the fastening location. The processing device 150 determines whether or not the task position is within the permissible task range, and outputs an alert when the task position is outside the permissible task range.

The permissible task range corresponds to the range in which the wearer can safely perform the task. By outputting the alert when the task position is outside the permissible task range, the worker can ascertain that the current position is improper for the task. For example, the worker approaches the fastening location according to the output of the alert. As a result, the task position moves into the permissible task range. The worker can perform the task safely in a more appropriate posture.

By displaying a virtual object that indicates the permissible task range, the worker can ascertain the permissible task range. When the alert is output, the worker can easily ascertain how far to move. Therefore, the convenience of the display device 100 can be improved.

According to the embodiment of the invention, a display device is provided in which the task can be performed more safely and with better convenience.

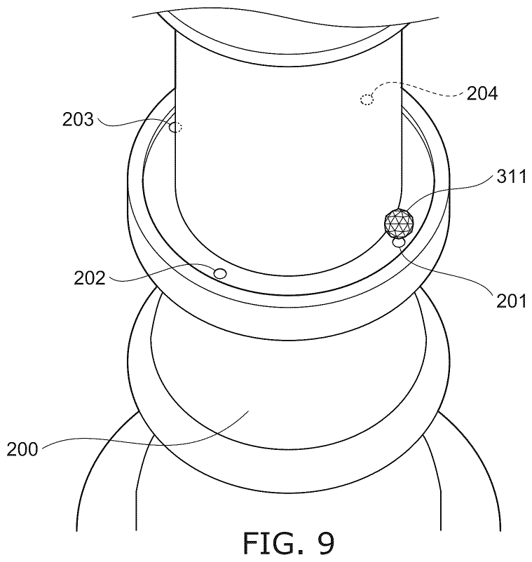

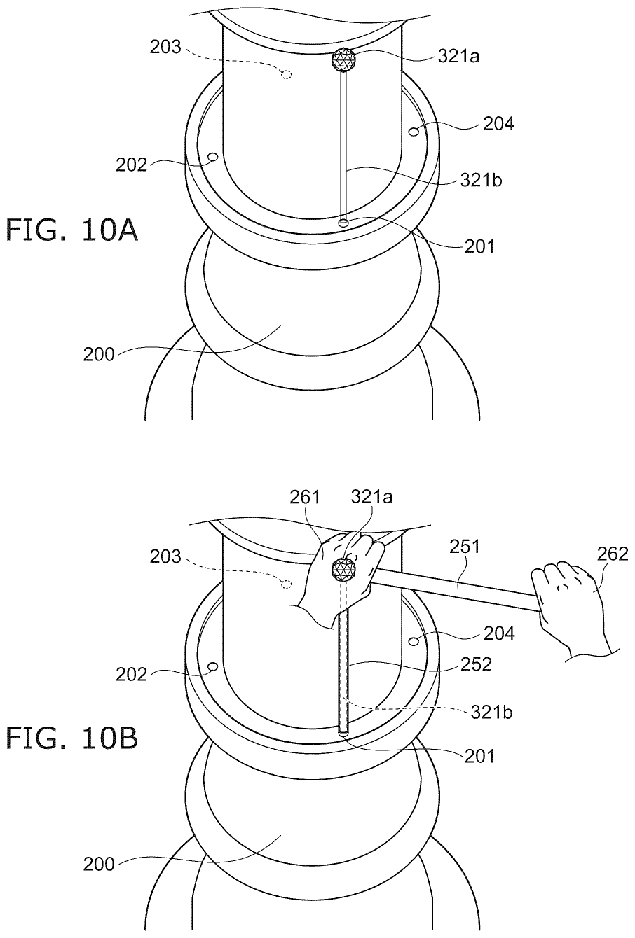

FIGS. 9, 10A, and 10B are schematic views showing display examples according to the display device according to the embodiment.

A virtual object other than the virtual object 301 may be displayed. For example, as shown in FIG. 9, the processing device 150 displays a virtual object 311 at the fastening location 201. The virtual object 311 is displayed at the fastening location at which the task is to be performed. Based on the display of the virtual object 311, the worker can easily ascertain the fastening location at which the task is to be performed.

The display position of the virtual object 311 may be preregistered, or may be calculated using the position of the fastening location 201. For example, the virtual object 311 is displayed to overlap the fastening location 201. In such a case, the position of the fastening location 201 is used as the display position of the virtual object 311. The virtual object 311 may be slightly separated from the fastening location 201 in the direction of the screw hole. In such a case, the display position that is separated from the fastening location 201 is preregistered. Or, when data of the fastener is preregistered, the display position of the virtual object 311 may be calculated using the position of the fastening location 201 and the length of the fastener. When the display position of the virtual object 311 is preregistered, the display position of the virtual object 311 may be used as the task position.

As shown in FIG. 10A, the processing device 150 may display a virtual object 321a (a second virtual object) and a virtual object 321b. The virtual object 321a is displayed at a position that is separated from the fastening location 201 in the direction of the screw hole. The virtual object 321b is displayed between the fastening location 201 and the virtual object 321a. The virtual object 321b indicates which fastening location corresponds to the virtual object 321a.

The virtual object 321a indicates the position at which the hand is to be placed when the screw is turned at the fastening location 201. The virtual object 321b indicates the position at which the extension bar is to be placed when the screw is turned at the fastening location 201. For example, the distance between the fastening location 201 and the virtual object 321a corresponds to the length of the extension bar.

In the illustrated example, the virtual object 321a is spherical; and the virtual object 321b is rod-shaped. The shapes of the virtual objects are not limited to the examples as long as the worker can visually recognize the virtual objects. For example, the virtual object 321a may be cubic; and the virtual object 321b may be wire-shaped.

The worker disposes the extension bar 252 so that the extension bar 252 approaches or contacts the virtual object 321b. The worker grips the head of the wrench 251 so that the hand contacts the virtual object 321a. Based on the display of the virtual objects 321a and 321b, the worker can easily ascertain the positions at which the tool and the hand are to be placed when the screw is turned at the fastening location 201. The work efficiency can be increased thereby.

The display positions of the virtual objects 321a and 321b may be preregistered, or may be calculated based on the position of the fastening location 201 and the data of the tool. When the display position of the virtual object 321a is preregistered, the display position of the virtual object 321a may be used as the task position.

After the virtual object 321a is displayed, the processing device 150 may determine whether or not a prescribed object contacts the virtual object 321a. For example, the processing device 150 determines whether or not a hand contacts the virtual object 321a. Specifically, the processing device 150 calculates the distance between the position of the hand and the position of the virtual object 321a. When the distance is less than a preset threshold, the processing device 150 determines that the hand contacts the virtual object 321a. As an example in FIG. 10A, the diameter of the virtual object 321a (a sphere) corresponds to the threshold. The sphere indicates the range in which the hand is determined to contact the virtual object 321a.

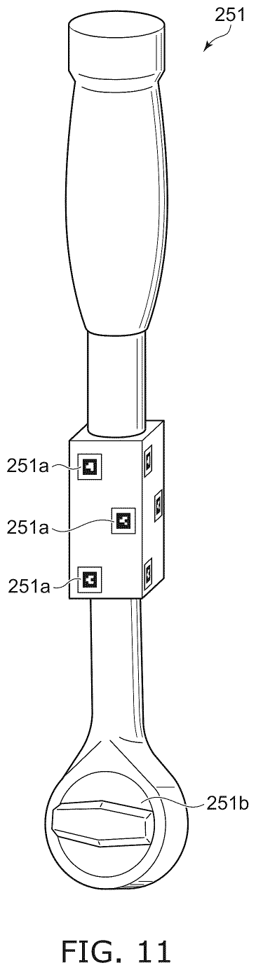

FIG. 11 is a schematic view showing an example of a tool.

The processing device 150 may determine whether or not the tool contacts the virtual object 321a. For example, as shown in FIG. 11, multiple markers 251a are mounted to the wrench 251. The processing device 150 recognizes the multiple markers 251a based on an image that is imaged by the image camera 131. The processing device 150 measures the positions of the markers 251a. The positional relationships between a head 251b of the wrench 251 and the multiple markers 251a are preregistered. The processing device 150 calculates the position of the head 251b based on the recognized positions of at least three markers 251a and the preregistered positional relationships. The processing device 150 calculates the distance between the position of the head 251b and the position of the virtual object 321a. When the distance is less than the preset threshold, the processing device 150 determines that the wrench 251 contacts the virtual object 321a.

When a prescribed object contacts the virtual object 321a, it can be estimated that a screw is being turned at the fastening location 201 corresponding to the virtual object 321a.

Other than the contact between the object and the virtual object, the fastening location at which the task is being performed may be estimated using the movement of the hand. The hand that turns the tool moves in an arc-like shape while the tool is used to turn the screw. At this time, the position of the center of the rotation substantially does not change. For example, the position of the head of the wrench substantially does not change while the screw is being turned with the wrench. It can be estimated that the screw is being turned when the change of the position of the rotation center is small.

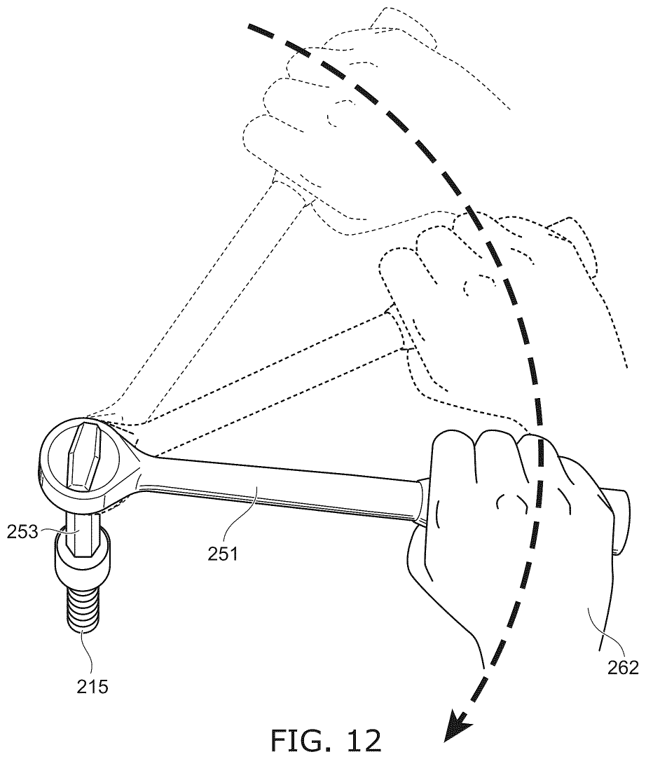

FIG. 12 is a schematic view showing a task.

For example, as shown in FIG. 12, the worker uses the wrench 251 to tighten a screw at a fastening location. Here, an example is described in which the extension bar 252 is not used. The worker places the screw 215 in a screw hole at a fastening location, which is not illustrated. The worker holds the grip of the wrench 251 with the right hand and causes the tip (the head) of the wrench 251 to which a socket is mounted to engage the screw 215. The worker turns the screw 215 by rotating the wrench 251.

The processing device 150 repeatedly measures the position of the hand while the worker turns the wrench 251. At this time, the hand is positioned on a circumference centered on a part of the wrench 251. The hand is moved to trace a circular arc. The processing device 150 utilizes this movement to estimate the center position of the rotation of the tool. The processing device 150 estimates the fastening location at which the screw is being turned, the performing of the task at the fastening location, etc., based on the center position of the rotation. For example, the following first or second calculation method is used to calculate the center position.

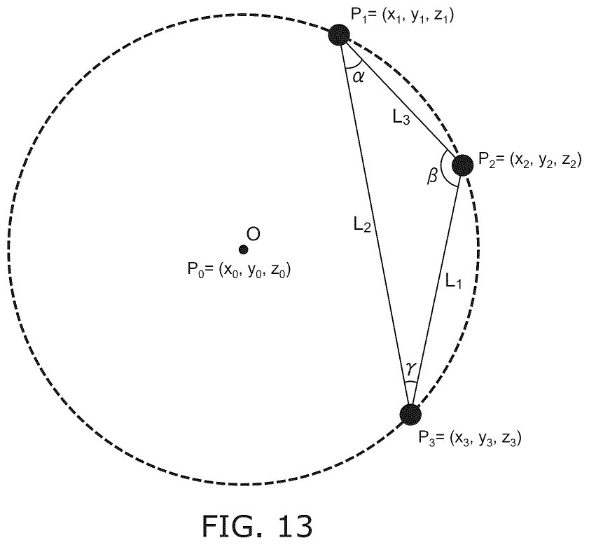

FIGS. 13, 14A, 14B, 15, and 16 are schematic views for describing calculation methods according to the first embodiment.

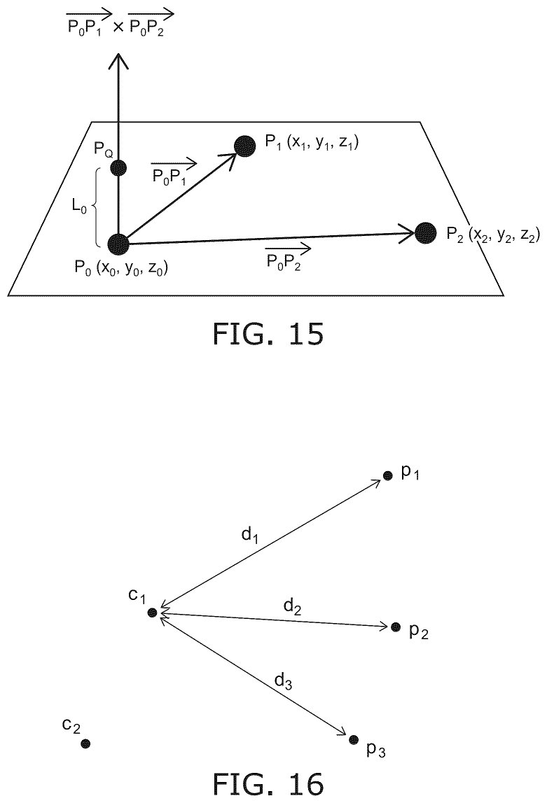

In the first calculation method, the processing device 150 extracts three mutually-different positions from the multiple positions that are measured. The processing device 150 calculates a circumcenter O of the three positions. Here, as shown in FIG. 15, the three positions are taken as P₁(x₁, y₁, z₁), P₂(x₂, y₂, z₂), and P₃(x₃, y₃, z₃). The position of the circumcenter O is taken as P₀(x₀, y₀, z₀). The length of the side opposite to the position P₁ of a triangle obtained by connecting the positions P₁ to P₃ to each other is taken as L₁. The length of the side opposite to the position P₂ is taken as L₂. The length of the side opposite to the position P₃ is taken as L₃. The angle at the position P₁ is taken as a. The angle at the position P₂ is taken as B. The angle at the position P₃ is taken as γ. In such a case, the position of the circumcenter O is represented by the following Formula (1). In Formula (1), the symbols marked with arrows represent position vectors. Formula (1) can be rewritten as Formula (2). Formula (2) can be broken down into Formulas (3) to (5).

$$[ Formula 1 ]$$

$$\vec{{P}_{0}} = \frac{{L}_{1}^{2} ( {L}_{2}^{2} + {L}_{3}^{2} - {L}_{1}^{2} ) \vec{P 1} + {L}_{2}^{2} ( {L}_{3}^{2} + {L}_{1}^{2} - {L}_{2}^{2} ) \vec{P 2} + {L}_{3}^{2} ( {L}_{1}^{2} + {L}_{2}^{2} - {L}_{3}^{2} ) \vec{P 3}}{{L}_{1}^{2} ( {L}_{2}^{2} + {L}_{3}^{2} - {L}_{1}^{2} ) + {L}_{2}^{2} ( {L}_{3}^{2} + {L}_{1}^{2} - {L}_{2}^{2} ) + {L}_{3}^{2} ( {L}_{1}^{2} + {L}_{2}^{2} - {L}_{3}^{2} )}$$

$$[ Formula 2 ]$$

$$( {x}_{0} , {y}_{0} , {z}_{0} ) = \frac{\begin{matrix}{L}_{1}^{2} ( {L}_{2}^{2} + {L}_{3}^{2} - {L}_{1}^{2} ) ( {x}_{1} , {y}_{1} , {z}_{1} ) + {L}_{2}^{2} ( {L}_{3}^{2} + {L}_{1}^{2} - {L}_{2}^{2} ) ( {x}_{2} , {y}_{2} , {z}_{2} ) + \\ {L}_{3}^{2} ( {L}_{1}^{2} + {L}_{2}^{2} - {L}_{3}^{2} ) ( {x}_{3} , {y}_{3} , {z}_{3} )\end{matrix}}{{L}_{1}^{2} ( {L}_{2}^{2} + {L}_{3}^{2} - {L}_{1}^{2} ) + {L}_{2}^{2} ( {L}_{3}^{2} + {L}_{1}^{2} - {L}_{2}^{2} ) + {L}_{3}^{2} ( {L}_{1}^{2} + {L}_{2}^{2} - {L}_{3}^{2} )}$$

$$[ Formula 3 ]$$

$${x}_{0} = \frac{{L}_{1}^{2} ( {L}_{2}^{2} + {L}_{3}^{2} - {L}_{1}^{2} ) {x}_{1} + {L}_{2}^{2} ( {L}_{3}^{2} + {L}_{1}^{2} - {L}_{2}^{2} ) {x}_{2} + {L}_{3}^{2} ( {L}_{1}^{2} + {L}_{2}^{2} - {L}_{3}^{2} ) {x}_{3}}{{L}_{1}^{2} ( {L}_{2}^{2} + {L}_{3}^{2} - {L}_{1}^{2} ) + {L}_{2}^{2} ( {L}_{3}^{2} + {L}_{1}^{2} - {L}_{2}^{2} ) + {L}_{3}^{2} ( {L}_{1}^{2} + {L}_{2}^{2} - {L}_{3}^{2} )}$$

$$[ Formula 4 ]$$

$${y}_{0} = \frac{{L}_{1}^{2} ( {L}_{2}^{2} + {L}_{3}^{2} - {L}_{1}^{2} ) {y}_{1} + {L}_{2}^{2} ( {L}_{3}^{2} + {L}_{1}^{2} - {L}_{2}^{2} ) {y}_{2} + {L}_{3}^{2} ( {L}_{1}^{2} + {L}_{2}^{2} - {L}_{3}^{2} ) {y}_{3}}{{L}_{1}^{2} ( {L}_{2}^{2} + {L}_{3}^{2} - {L}_{1}^{2} ) + {L}_{2}^{2} ( {L}_{3}^{2} + {L}_{1}^{2} - {L}_{2}^{2} ) + {L}_{3}^{2} ( {L}_{1}^{2} + {L}_{2}^{2} - {L}_{3}^{2} )}$$

$$[ Formula 5 ]$$

$${z}_{0} = \frac{{L}_{1}^{2} ( {L}_{2}^{2} + {L}_{3}^{2} - {L}_{1}^{2} ) {z}_{1} + {L}_{2}^{2} ( {L}_{3}^{2} + {L}_{1}^{2} - {L}_{2}^{2} ) {z}_{2} + {L}_{3}^{2} ( {L}_{1}^{2} + {L}_{2}^{2} - {L}_{3}^{2} ) {z}_{3}}{{L}_{1}^{2} ( {L}_{2}^{2} + {L}_{3}^{2} - {L}_{1}^{2} ) + {L}_{2}^{2} ( {L}_{3}^{2} + {L}_{1}^{2} - {L}_{2}^{2} ) + {L}_{3}^{2} ( {L}_{1}^{2} + {L}_{2}^{2} - {L}_{3}^{2} )}$$

x₀, y₀, and z₀ are calculated respectively from Formulas (3) to (5). The processing device 150 calculates the position P₀(x₀, y₀, z₀) of the circumcenter O as the center position of the rotation of the wrench 251.

The center position of the rotation of the wrench 251 can be considered to be the position at which the screw 215 is being turned by the wrench 251. Then, it can be estimated that the screw is being tightened at the fastening location most proximate to the center position. For example, the processing device 150 extracts a combination of the three positions from the multiple positions of the hand measured in a prescribed duration, and calculates the center position. The processing device 150 repeats the extraction of the combination of the positions and the calculation of the center position. The processing device 150 calculates the distances between the fastening location and the center positions calculated for the duration, and estimates that the screw is being turned at the fastening location when one of the distances is less than a threshold.

When a digital tool that can detect the torque value is used, the detection result of the tool may be used to estimate the task. For example, when the torque value is detected by the tool and the distances between the fastening location and the center positions for a prescribed duration all are less than the threshold, the processing device 150 estimates that the screw is being turned at the fastening location.

To more accurately estimate the position of the screw in the first calculation method described above, the length of the tool interposed between the wrench 251 and the screw 215 may be used in the calculation. In the example shown in FIG. 12, a socket 253 engages the wrench 251. In other words, the center position of the rotation of the wrench 251 and the position of the screw 215 are separated by the length of the socket 253. When the length of the socket 253 is preregistered, the processing device 150 can use the center position and the length of the socket 253 to more accurately estimate the position of the screw 215.

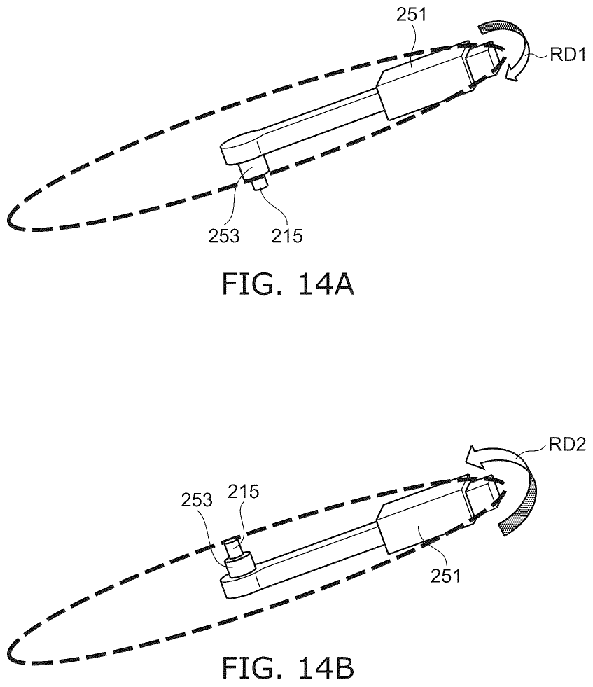

When using the length of the socket 253 to estimate the position of the screw 215, it is necessary to determine the side at which the screw 215 is positioned with respect to the plane in which the wrench 251 is rotating. In the example shown in FIG. 14A, the wrench 251 rotates in a rotation direction RD1. The screw 215 and the socket 253 are positioned at the lower side. In the example shown in FIG. 14B, the wrench 251 rotates in a rotation direction RD2. The rotation direction RD2 is the opposite of the rotation direction RD1. The screw 215 and the socket 253 are positioned at the upper side of a plane parallel to the rotation direction RD2.

To determine the side at which the screw 215 is positioned, the processing device 150 uses the center position, two positions of the hand, time-series information of the two positions, and tighten/loosen information of the screw. For example, as shown in FIG. 27, the two positions are taken as P₁(x₁, y₁, z₁) and P₂(x₂, y₂, z₂). The center position is taken as P₀(x₀, y₀, z₀). The time at which the hand is at the position P₁ and the time at which the hand is at the position P₂ are known. In other words, the processing device 150 stores time-series information of the positions P₁ and P₂. In the example, the time at which the hand was positioned at the position P₁ is before the time at which the hand was positioned at the position P₂.

The tighten/loosen information indicates whether the screw is being tightened or loosened. When the wrench 251 is a digital tool, the wrench 251 generates the tighten/loosen information by determining whether the screw is being tightened or loosened based on the detected torque value. The processing device 150 may generate the tighten/loosen information by determining whether the screw is being tightened or loosened based on the time-series data of the torque value received from the wrench 251.

A plane that passes through the positions P₀ to P₂ is represented by the following Formula (6). In Formula (6), k, l, m, and n are constants.

$$kx + ly + mz + n = 0 \qquad [ Formula 6 ]$$

The following Formulas (7) to (9) are obtained by substituting the coordinates of P₀ to P₂ in Formula (6). The constants k, l, m, and n are calculated from Formulas (7) to (9).

$${kx}_{0} + {ly}_{0} + {mz}_{0} + n = 0 \qquad [ Formula 7 ]$$

$${kx}_{1} + {ly}_{1} + {mz}_{1} + n = 0 \qquad [ Formula 8 ]$$

$${kx}_{2} + {ly}_{2} + {mz}_{2} + n = 0 \qquad [ Formula 9 ]$$

Here, the processing device 150 calculates a vector from the center position P₀ to the position P₁ at the previous time. Also, the processing device 150 calculates a vector from the center position P₀ to the position P₂ at the subsequent time. The screw 215 is at a position P₀ that is separated from the center position P₀ by a length L₀ of the socket 253 on the normal vector P₀P₁×P₀P₂. When the screw is being tightened and the time of the position P₁ is before the time of the position P₂, the processing device 150 calculates the normal vector P₀P₁×P₀P₂ of the vector P₀P₁ and the vector P₀P₂.

The length from the position P₀ to the position P₀ at which the wrench and the socket act on the screw is represented by the following Formula (10). In the following formulas, the symbols marked with arrows indicate that the value of the symbol is a vector.

$$\vec{\vert {P}_{0} {P}_{Q}} \vert = √ {\{ ( k - {x}_{0} \}}^{2} + {( l - {y}_{0} )}^{2} + {( m - {z}_{0} )}^{2} \} = {L}_{0} \qquad [ Formula 10 ]$$

On the other hand, the vector from the position P₀ to the position P₀ also may be represented by the following Formula (11). In Formula (11), t is a constant.

$$\vec{{P}_{0} {P}_{Q}} = ( k - {x}_{0} , l - {y}_{0} , m - {z}_{0} ) = t ( k , l , m ) \qquad [ Formula 11 ]$$

The following Formula (12) is obtained by substituting Formula (11) in Formula (10). The length L₀ in Formula (12) is preregistered. t is calculated by solving Formula (12).

$$[ Formula 12 ]$$

$$√ \{ ( {\{ ( {y}_{1} - {y}_{0} ) ( {z}_{2} - {z}_{0} ) - ( {y}_{2} - {y}_{0} ) ( {z}_{2} - {z}_{0} ) \}}^{2} * {t}^{2} + \{ ( {z}_{1} - {z}_{0} ) ( {x}_{2} - {x}_{0} ) - ( {z}_{2} - {z}_{0} ) ( {x}_{1} - {x}_{0} ) \} * {t}^{2} + \{ ( {x}_{1} - {x}_{0} ) ( {y}_{2} - {y}_{0} ) - ( {x}_{2} - {x}_{0} ) ( {y}_{1} - {y}_{0} ) \} * {t}^{2} \} = {L}_{0}$$

When t is calculated, the position P₀ is calculated using the position P₀ and the constants k, l, m, n, and t. In other words, the position of the screw is obtained.

For example, the processing device 150 extracts a combination of three positions from the multiple positions of the screw 215 calculated for a prescribed duration, and calculates the center position. The processing device 150 repeats the extraction of the combination of the positions and the calculation of the center position. The processing device 150 estimates that the screw is being turned at the fastening location when one of the distances between the fastening location and the positions of the screw 215 in the duration is less than a threshold.

As shown in FIG. 5C, there are cases where the screw is fastened via the extension bar 252. In such a case as well, similarly to the method described above, the position of the screw 215 can be estimated using the length of the extension bar 252. In other words, the screw 215 is at a position separated from the center position P₀ by the sum of the length of the extension bar 252 and the length of the socket 253 on the normal vector P₀P₁×P₀P₂. The position P₀ of the screw 215 is estimated using the center position P₀, the length of the extension bar 252, and the length of the socket 253. The position of the screw 215 can be estimated with higher accuracy by considering the length of another tool interposed between the screw 215 and the wrench 251.

In the second calculation method, the center position of the rotation is preregistered for each fastening location. For example, as shown in FIG. 16, center positions c1 and c2 are preregistered for the fastening locations 201 and 202. Three positions p1 to p3 of the hand are calculated based on images of the hand turning the screw. The processing device 150 calculates distances d1 to d3 respectively between the center position c₁ and the positions p1 to p3. Similarly, the processing device 150 calculates the distances respectively between the center position c₂ and the positions p1 to p3. The processing device 150 calculates the fluctuation of the distances respectively between the center position c₁ and the positions p1 to p3, and calculates the fluctuation of the distances respectively between the center position c₂ and the positions p1 to p3. When one of the fluctuations is less than a threshold, the processing device 150 estimates that the tool is rotating at that center position. The processing device 150 estimates that the screw is being turned at the fastening location associated with the estimated center position. Examples of the fluctuation include an average value of multiple distances, a sum of differences between the distances, the sum and variance of the multiple distances, the standard deviation of the multiple distances, etc. In the example shown in FIG. 16, the positions p1 to p3 of the hand are substantially equidistant from the center position c₁. It is therefore estimated that the screw is being turned at the fastening location 201 associated with the center position c₁.

When a digital tool is used, the detection result of the tool may be used to estimate the task. For example, when the center position is estimated and the torque value is detected by the tool, the processing device 150 estimates that the screw is being turned at the fastening location associated with the center position.

The processing device 150 may repeat the first or second calculation method regardless of whether or not the task is being performed. Specifically, the processing device 150 uses multiple positions of the hand obtained in a prescribed duration to perform the first or second calculation method. When it is not estimated that the task is being performed based on the multiple positions of the hand in the duration, the processing device 150 slides the duration and re-performs the first or second calculation method. As an example, the duration is set to 6 seconds; and the slide amount is set to 16 milliseconds. The duration and the slide amount are appropriately set according to the performance of the processing device 150.

When the task is not being performed, the tool does not actually rotate, and there is no center of rotation. However, an apparent center position can be calculated based on multiple positions of the hand. While the task is not being performed, the calculated center position is separated from the positions of the fastening locations. It is therefore not estimated that the task is being performed. When the task is performed, the calculated center position approaches the position of the fastening location. The processing device 150 estimates the timing at which the task is initially estimated to be performed to be the start of the task.

When the fastening location at which the task is being performed is estimated based on the movement of the hand or contact between the virtual object and the prescribed object, the processing device 150 may associate the record of the task with data of the fastening location. The record of the task indicates that the screw is turned at the fastening location. The task record is automatically generated thereby.

When a digital tool such as a digital torque wrench, a digital torque driver, or the like is used, the processing device 150 receives the detected torque value from the tool. The torque value necessary for the fastening may be preset, and the digital tool may determine whether or not the necessary torque value is detected. The digital tool transmits the determination result to the processing device 150. The digital tool also transmits the rotation angle, the time at which the torque value was detected, etc., to the processing device 150. For example, the processing device 150 associates the maximum received torque value or the determination result with data of the task location. A more detailed task record is automatically generated thereby.

Based on the received torque value, the processing device 150 may determine whether or not the estimated task at the fastening location has ended. When the received torque value is not less than a preset torque value, the processing device 150 determines that the task at the fastening location has ended.

When a determination result indicating whether or not the necessary torque value is detected is received from the tool, the processing device 150 may determine whether or not the task at the fastening location is completed based on the determination result.

After the task is estimated to be performed at the fastening location, and when a state in which the task cannot be estimated at the fastening location or a state in which the torque value is not received has continued for a prescribed period or more, the processing device 150 may determine that the task at the fastening location has ended.

There are cases where a screw is tightened multiple times at one fastening location. For example, after screws are tightened respectively at the fastening locations 201 to 204, the screws are re-tightened again at the fastening locations. In such a case, the processing device 150 may count the number of times that the screw is tightened. After it is estimated that the task is being performed, the screw-tightening count is incremented when it is determined that the task is completed.

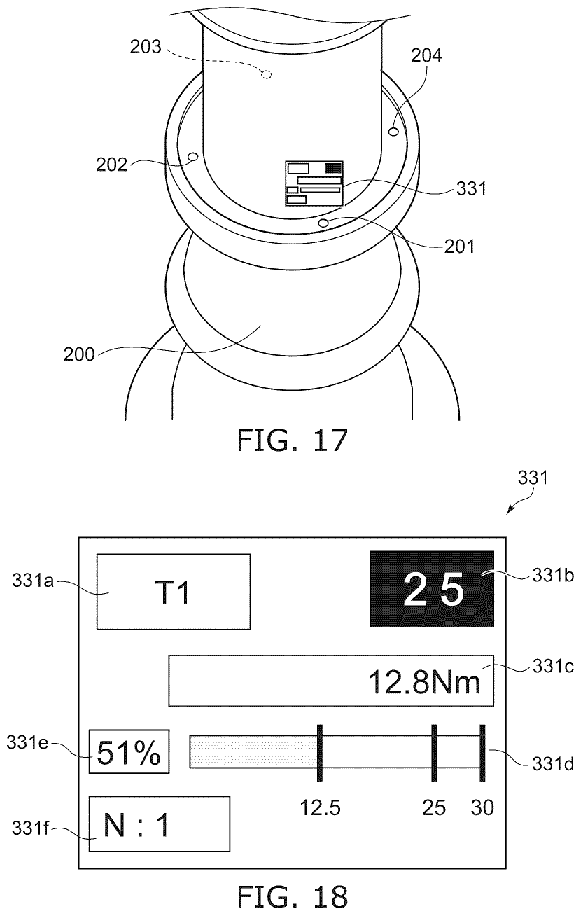

FIG. 17 and FIGS. 19 to 23 are schematic views showing display examples according to the display device according to the embodiment. FIG. 18 is a schematic view showing a specific example of a virtual object.

As shown in FIG. 17, the processing device 150 may display a virtual object 331 (a third virtual object). The virtual object 331 includes information of the task at the fastening location 201. The virtual object 331 is displayed proximate to the fastening location 201. For example, the distance between the fastening location 201 and the virtual object 331 is less than the distance between the virtual object 331 and the other fastening locations 202 to 204. The information of the virtual using characters (logograms, object 331 is illustrated phonograms, or ideograms). Based on the virtual object 331, the worker can ascertain the information necessary for the task.

For example, as shown in FIG. 18, the virtual object 331 includes task information such as identification information 331a, a specified torque value 331b, a detected value 331c, a meter 331d, a percentage 331e, and a count 331f. The identification information 331a is unique identification information assigned to the fastening location 201 and is represented by a character string. The specified torque value 331b is the torque value necessary for screw-tightening at the fastening location 201, and is prespecified.

In the task, a tool that can detect the torque value may be used. In such a case, the detected value 331c is the torque value detected by the tool. The meter 331d indicates the specified torque value and the detected torque value. The percentage 331e indicates the ratio of the detected value to the specified torque value. According to the task, it may be desirable to tighten the screw multiple times at one fastening location. In such a case, the count 331f indicates the number of times that the screw is tightened at the fastening location 201. The worker performs the task while confirming the content displayed in the virtual object 331.

When the sequence of the task for multiple fastening locations is specified, the display of the virtual object 331 indicates the fastening location at which the task is to be performed. Based on the virtual object 331, the worker can confirm the information of the task, and can ascertain the fastening location at which the task is to be performed.

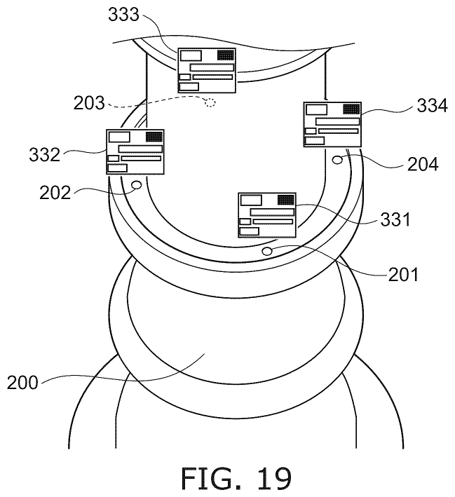

As shown in FIG. 19, the processing device 150 may display the virtual objects 331 to 334 respectively at the fastening locations 201 to 204. The virtual objects 331 to 334 include information of the task respectively for the fastening locations 201 to 204. Based on the display of the virtual objects 331 to 334, the worker can simultaneously confirm the information of the task at the fastening locations.

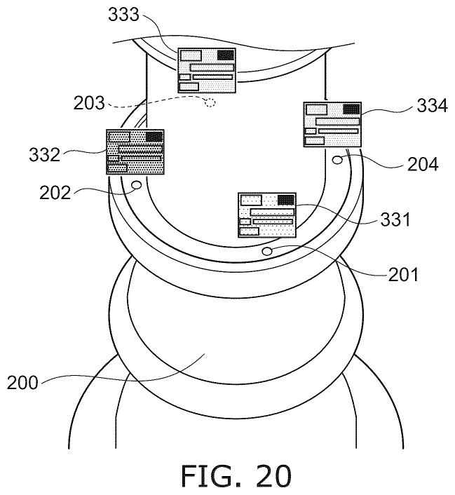

The display form of the virtual objects 331 to 334 may indicate the fastening location at which the task is to be performed, the screw-tightening count, etc. In the example shown in FIG. 20, the next task to be performed is at the fastening location 202. A virtual object 332 that is displayed at the fastening location 202 is displayed to be darker than the other virtual object 331, virtual object 333, and virtual object 334. Also, the colors of the virtual objects 331 to 334 change according to the screw-tightening count. In the illustrated example, the screw has been tightened once at the fastening locations 202 to 204; and the screw has been tightened twice at the fastening location 201. Therefore, the color of the fastening location 201 is different from the color of the fastening locations 202 to 204.

Other than the darkness and color of the display, the fastening location at which the task is to be performed and the screw-tightening count may be indicated by the size, a change of the display (animation), etc. As in the virtual objects 321a and 321b, virtual objects that indicate the fastening location at which the task is to be performed also may be displayed.

After all of the tasks have ended, the processing device 150 may determine whether or not the task is appropriately performed at the fastening locations 201 to 204. The processing device 150 refers to the record generated for the task at the fastening locations 201 to 204. The processing device 150 determines whether or not the maximum received torque values for the task at the fastening locations are not less than the prescribed toque value. The processing device 150 also determines whether or not the number of times that the screw is tightened for each fastening location is not less than a prescribed count. The processing device 150 outputs an alert when the received torque value is less than the prescribed torque value or when the screw-tightening count is less than the prescribed count.

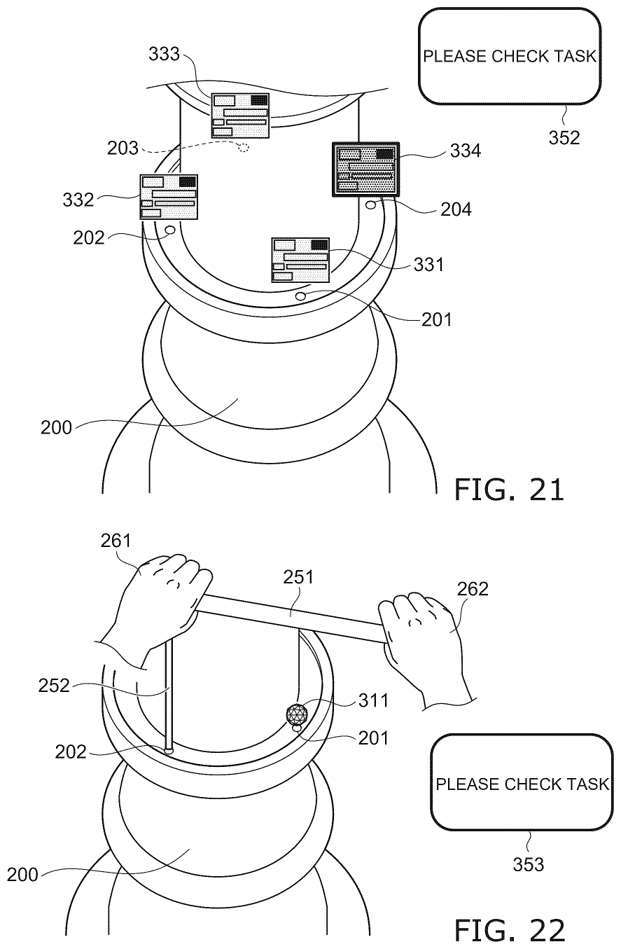

For example, the screws are set to be tightened twice at each of the fastening locations 201 to 204. The screws have been tightened twice at the fastening locations 201 to 203, and the screw has been tightened only once at the fastening location 204. In such a case, as shown in FIG. 21, the processing device 150 causes the display form of the virtual object 334 corresponding to the fastening location 204 to be different from the display forms of the virtual objects 331 to 333. The frame of the virtual object 334 is displayed to be thicker than the frames of the virtual objects 331 to 333; and the virtual object 334 is enhanced. The change of the display form of the virtual object 334 functions as an alert (an example of a second alert). The processing device 150 may display an alert 352 (another example of the second alert) that includes a message. An alert is output similarly when the torque value at one of the fastening locations is less than the prescribed torque value.

A sound, light, a vibration, etc., may be output as an alert instead of the display or in addition to the display. Based on the output of the alert, the worker can ascertain that the task is inappropriate at one of the fastening locations. For example, the worker confirms which fastening location was subjected to the inappropriate task based on the information included in the virtual objects 331 to 334. The worker performs rework of the task for the one of the fastening locations. As a result, the worker can be prompted to perform the appropriate task.

When the sequence of the task for multiple fastening locations is specified, the processing device 150 also can determine whether or not the fastening location at which the task is being performed is appropriate. For example, the processing device 150 determines the next fastening location on which the task is to be performed based on the record of the task up to that point. The processing device 150 determines whether or not the fastening location at which it is estimated that the task is being performed and the next fastening location on which the task is to be performed match. When it is estimated that the task is being performed at a fastening location different from the fastening location at which the task should be performed, the processing device 150 may display an alert 353 as shown in FIG. 22. A sound, light, a vibration, etc., may be output as an alert instead of the message or in addition to the message such as the alert 353.

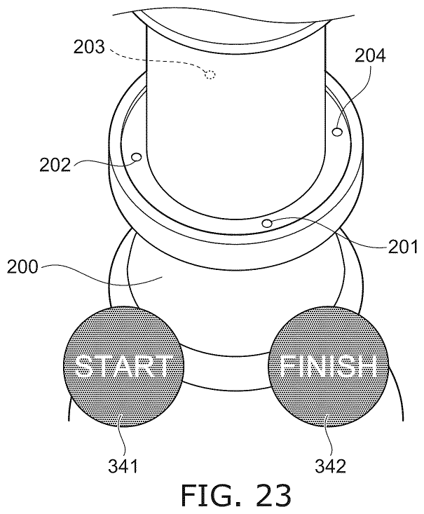

As shown in FIG. 23, virtual objects 341 and 342 may be displayed. The virtual object 341 is displayed to start the processing according to the processing device 150. The virtual object 342 is displayed to end the processing according to the processing device 150. For example, the three-dimensional coordinate system is set by the processing device 150. Subsequently, the worker contacts the virtual object 341 with a finger when preparation of the task is completed. When it is determined that the hand of the worker contacted the virtual object 341, the processing device 150 starts the processing such as the setting of the permissible task range, the setting of the task position, the comparison between the task position and the permissible task range, etc.

A voice command or a hand gesture may be used instead of contact with the virtual object 341. When the preparation of the task is completed, the worker utters a voice command or makes a hand gesture with a hand. The processing device 150 detects a voice command based on the voice acquired by the microphone 141. Or, the processing device 150 detects the hand gesture based on the result of hand tracking.

For example, the processing device 150 automatically repeats the spatial mapping. The processing device 150 also automatically sets the three-dimensional coordinate system when the marker 210 is recognized based on an image. Accordingly, the processing such as the setting of the permissible task range, the setting of the task position, the comparison between the task position and the permissible task range, etc., can be performed when the task to be performed is determined and the three-dimensional coordinate system is set. For example, if such processing is performed while the worker is preparing for the task, the task position may be determined to be outside the permissible task range. There is a possibility that an alert may be continuously output during the preparation for the task; and the preparation of the task may be obstructed.

For this problem, an instruction that indicates the preparation completion of the task is input to the display device 100 by one of contact of the virtual object 341, a voice command, or a hand gesture. The processing device 150 starts the processing according to the instruction. As a result, the needless output of an alert when the preparation of the task is incomplete can be avoided. The behavior of the worker is not easily obstructed by an alert; and the convenience of the display device 100 can be improved.

When the task is completed, the worker contacts the virtual object 342 with a finger. When it is determined that the hand of the worker has contacted the virtual object 342, the processing device 150 ends the processing. For example, after the contact with the virtual object 341, the fastening location at which the task is being performed is estimated. Based on the contact with the virtual object 342, the processing device 150 determines that the estimated task at the fastening location has ended. Instead of the contact with the virtual object 342, an instruction that indicates the end of the task by a voice command or a hand gesture may be input to the display device 100.

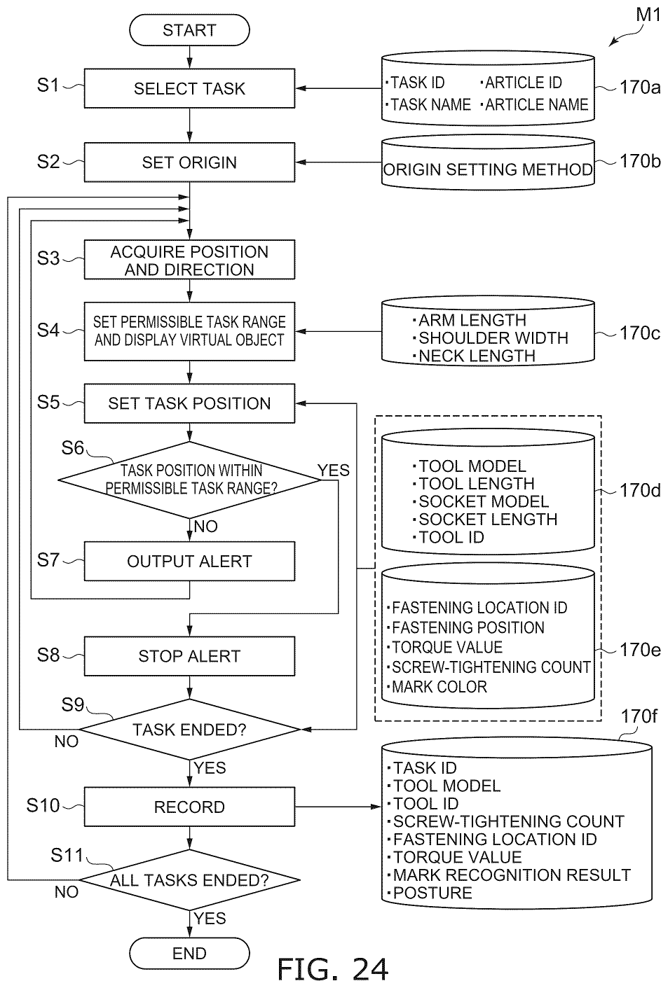

FIG. 24 is a flowchart showing a processing method according to the embodiment.

Task master data 170a, origin master data 170b, tool master data 170d, and fastening location master data 170e are prepared before the processing method M1 shown in FIG. 24 is performed. The master data is registered in the storage device 170.

First, the task to be performed is selected (step S1). The task ID, the task name, the article ID, and the article name are registered in the task master data 170a. The task is designated by the task ID, the task name, the ID of the article on which the task is performed, the name of the article, etc. The processing device 150 accepts the selection of the task. For example, the task to be performed is selected by the worker. The task to be performed may be selected by a higher-level system; and the processing device 150 may accept the selection. The processing device 150 may determine the task to be performed based on the data obtained from the image camera 131 or another sensor. The processing device 150 selects the task based on the determination result.

Then, the image camera 131 images the marker 210. The processing device 150 sets the origin of the three-dimensional coordinate system by using the position and orientation of the marker 210 as a reference (step S2). At this time, the processing device 150 refers to the origin master data 170b. The setting method of the origin is registered for each task in the origin master data 170b. The processing device 150 acquires the setting method of the origin for the selected task and sets the origin according to the setting method.

After setting the origin, the processing device 150 acquires the position and direction of the display device 100 (step S3). Spatial mapping or another positioning system is used to acquire the position and the direction.

The processing device 150 refers to physique data registered in physique master data 170c. For example, the arm length, the neck length, and the shoulder width are registered as the physique data. Or, more simply, the maximum distance between the display device 100 and the hand within the range in which the task can be performed safely may be registered as the physique data. Or, the permissible task range with respect to the position and direction of the display device 100 may be preregistered. In such a case, the preregistered permissible task range is referenced instead of the physique data. The processing device 150 sets the permissible task range by using the position and direction of the display device 100 and any of the data. The processing device 150 displays a virtual object indicating the permissible task range (step S4).

The processing device 150 sets the task position (step S5). The tool master data 170d and the fastening location master data 170e are referenced as appropriate when setting the task position. For example, the position of the fastening location is set as the task position. Or, the task position may be calculated using the position of the fastening location and the data of the tool.

The ID of the tool to be used, the model of the tool, the length of the tool, the model of the socket, the length of the socket, etc., are registered for each task in the tool master data 170d. The model of the tool indicates the classification of the tool by structure, exterior shape, performance, etc. The length of the tool is the length from the rotation center to the grip when the tool is used for screw-tightening. The model of the socket indicates the classification of the socket by structure or exterior shape. The length of the socket refers to the length of the socket in the direction connecting the tool and the screw when tightening the screw. The processing device 150 acquires, from the tool master data 170d, the data of the tool used in the task selected in step S1. When an extension bar is used, the model, the length, etc., of the extension bar also are registered in the tool master data 170d. The processing device 150 also acquires the data related to the extension bar from the tool master data 170d.

The ID of the fastening location, the position of the fastening location, the necessary torque value, and the screw-tightening count are registered for each fastening location in the fastening location master data 170e. The fastening position indicates the position at which the fastening location is present; and the coordinate in the three-dimensional coordinate system set in step S2 is registered. The screw-tightening count is the number of times that the screw must be tightened for each fastening location. When the screw is to be marked after fastening, the color of the mark also is registered.

The processing device 150 determines whether or not the task position is within the permissible task range (step S6). When the task position is outside the permissible task range, the processing device 150 outputs an alert (step S7). After outputting the alert, step S3 is re-performed. For example, the worker moves according to the alert; and the position and direction of the display device 100 after the movement are acquired. A new permissible task range is set, and the display of the virtual object indicating the permissible task range is updated. When the task position moves within the permissible task range as a result, the processing device 150 stops the alert (step S8). Step S8 is omitted when it is determined that the task position is within the permissible task range while the alert is not being output.

The processing device 150 determines whether or not the task has ended (step S9). As described above, the end of the task is determined based on the estimation result of the task being performed, the data received from the tool, etc. When the task has not ended, step S3 is re-performed.

When it is determined that the task has ended, the processing device 150 generates a record of the task for the fastening location at which it is estimated that the task is being performed (step S10). The generated record is stored in history data 170f. For example, the torque value that is detected by the tool is associated with the ID of the task and the ID of the estimated fastening location. As illustrated, the processing device 150 also may associate the model and ID of the tool used, the screw-tightening count, and the recognition result of the mark with the ID of the fastening location. The mark is recognized by the processing device 150 based on the image that is imaged by the image camera 131. The processing device 150 extracts an aggregate of pixels of the mark color from the image and counts the number of pixels in the aggregate. When the number of pixels is greater than a preset threshold, a mark is determined to be present.

The processing device 150 determines whether or not the task has ended at all of the fastening locations (step S11). When all of the tasks have not ended, step S3 is re-performed. Subsequently, the task position that corresponds to the next fastening location is set in step S5.

The processing device 150 may record the comparison result between the task position and the permissible task range in the history data 170f. In the example shown in FIG. 24, the determination result is associated as “posture” with the data of the fastening location. For example, even in a state in which the task position is outside the permissible task range and the alert is being output, the task may be determined to have ended when the task is estimated to be performed and the preset torque value is detected. In such a case, the processing device 150 associates first data with the data of the fastening location to indicate that the task was performed in a state in which the task position was outside the permissible task range. The assignment of the first data means that the task was performed in an improper posture. The processing device 150 also may associate second data with the data of the fastening location when the task was performed in a state in which the task position was within the permissible task range. The assignment of the second data means that the task was performed in an appropriate posture.

Based on the assignment of the first data, it can be easily confirmed whether or not the worker performed the task in an appropriate posture when reviewing the task record. For example, when the worker is injured, etc., the cause can be checked more easily by confirming the presence or absence of the first data in the task record.

Or, when the first data is frequently assigned, there is also a possibility that the permissible task range is too narrow. In such a case, when the permissible task range is excessively narrow, there is a possibility that the position of the worker may be needlessly constrained, and the efficiency of the task may be reduced. Accordingly, a correction of the permissible task range also may be considered when the first data is frequently assigned.

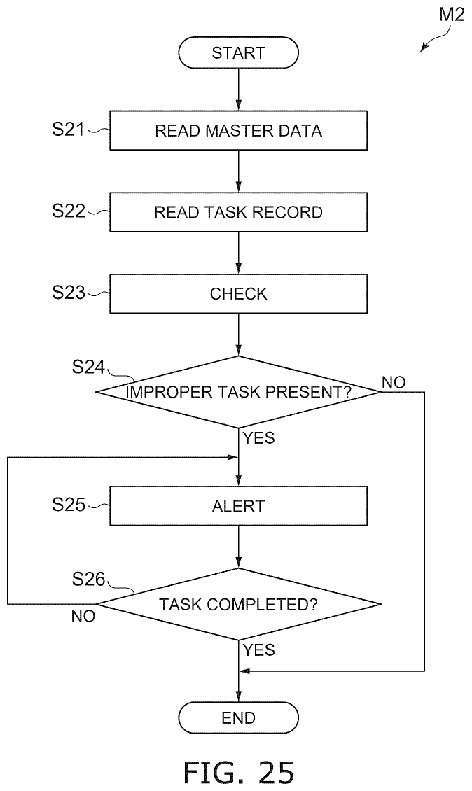

FIG. 25 is a flowchart showing a confirmation method according to the embodiment.

The confirmation method M2 shown in FIG. 25 may be performed after determining in step S11 that all of the tasks have ended. First, the processing device 150 reads each set of master data (step S21). The data of the task master data 170a, the tool master data 170d, the fastening location master data 170e, etc., is read. Then, the processing device 150 reads the task record stored in the history data 170f (step S22).

The processing device 150 compares the information of the master data and the information of the task record that are read and checks that the task was appropriately performed for the fastening locations (step S23). As described above, when the received torque value is less than the prescribed torque value or when the screw-tightening count is less than the prescribed count for any of the fastening locations, the task is determined to be improper at that fastening location.

The processing device 150 determines whether or not a task that is determined to be improper is present (step S24). If any improper task is present, the processing device 150 outputs an alert (step S25). The worker performs the task again according to the alert. Subsequently, the processing device 150 determines whether or not the task at the fastening location determined to be improper is completed (step S26). When the torque value is insufficient at any of the fastening locations, the processing device 150 determines that the task is completed when the task at the fastening location is estimated and a torque value of not less than the prescribed torque value is received from the tool. When the screw-tightening count is insufficient for any of the fastening locations, the processing device 150 determines that the task is completed when the task at the fastening location is estimated and the screw-tightening count reaches the prescribed count.

When it is determined that there is no improper task in step S24, or when it is determined that the task is completed in step S26, the processing device 150 ends the processing of the confirmation.

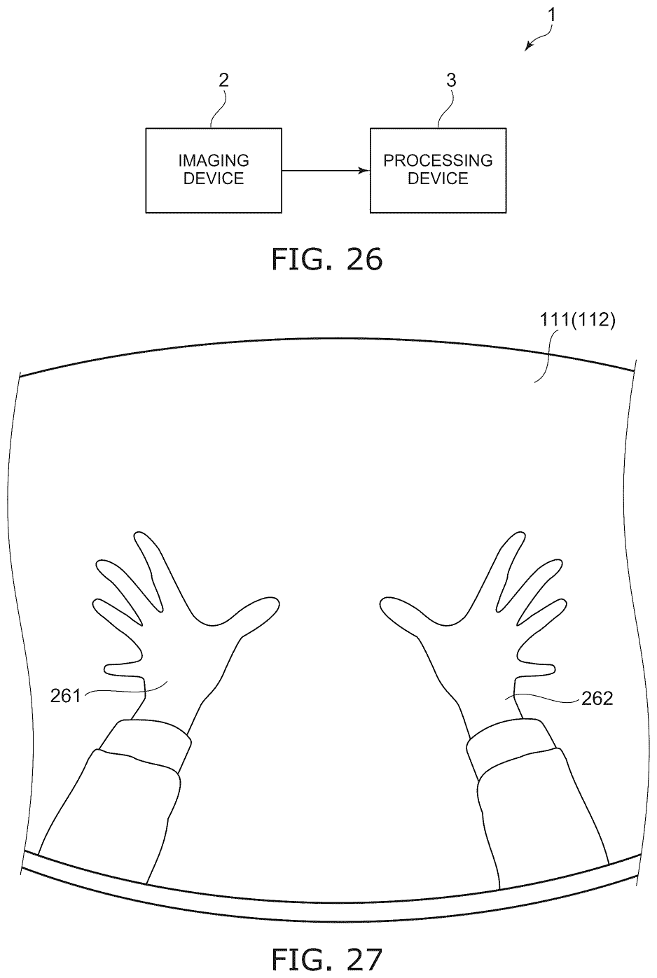

FIG. 26 is a schematic view showing a configuration of an acquisition system according to the embodiment.

The acquisition system 1 shown in FIG. 26 acquires the physique data referenced by the processing device 150. The acquisition system 1 includes an imaging device 2 and a processing device 3.

The imaging device 2 acquires an image by imaging the worker. An image in which at least the upper body is visible is acquired. The imaging device 2 includes a camera. The processing device 3 receives the image acquired by the imaging device 2. The processing device 3 inputs the image to a posture estimation model. When the image is input to the posture estimation model, the posture of the person visible in the image is estimated. The posture is represented by the joints of the human body and the skeleton connecting the joints to each other. The joints are the head, the neck, the shoulders, the elbows, the wrists, the fingers, the lower back, the knees, the ankles, etc.

It is favorable for the posture estimation model to include a neural network. More favorably, the posture estimation model includes a convolutional neural network (CNN). OpenPose, DarkPose, CenterNet, etc., can be used as the posture estimation model.

The processing device 3 acquires an estimation result output from the posture estimation model. The processing device 3 calculates the physique data of the arm length, the shoulder width, the neck length, etc., based on the estimated posture. The processing device 3 registers the calculated physique data in the physique master data 170c. By using the acquisition system 1, the physique data of the wearer of the display device 100 can be easily acquired.

The display device 100 may include a function as the acquisition system 1. For example, the worker extends a hand as far as possible within the range in which the task can be performed safely while wearing the display device 100. The processing device 150 measures the position of the hand based on an image of the extended hand. The processing device 150 also calculates the position and direction of the display device 100 at that time. The processing device 150 calculates the distance between the position of the display device 100 and the position of the hand, and registers the distance in the physique master data 170c.

FIG. 27 is a schematic view for describing processing in a registration mode of the permissible task range.

The display device 100 may be configured to perform a registration mode to register the permissible task range. The worker wears the display device 100 and performs the registration mode. As shown in FIG. 27, the worker extends the arms to the limit of the range considered to be where the task can be safely performed. The processing device 150 measures the position of the left hand 261 and the position of the right hand 262 at that time. The processing device 150 measures the distances from the position of the display device 100 to the hands. The processing device 150 uses the distances to calculate the permissible task range, and registers the permissible task range.

Or, the worker may move the hands within the range considered to be where the task can be safely performed. The processing device 150 repeats the measurement of the positions of the hands and calculates the permissible task range indicated by the movement of the hands. The processing device 150 registers the obtained permissible task range.

For example, the display device 100 is an AR device that displays augmented reality (AR), or a MR device that displays mixed reality (MR). When the display device 100 is realized as a MR device, contact between a virtual object and an actual object can be detected. Accordingly, it is favorable for the display device 100 to be a MR device when the task is estimated to be performed based on the contact between the prescribed object and the virtual object.

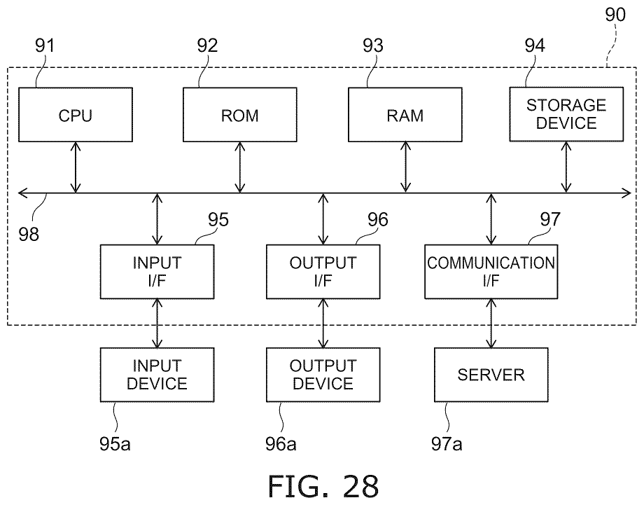

FIG. 28 is a schematic view showing a hardware configuration.

For example, a computer 90 shown in FIG. 28 is used as the processing device 3 or the processing device 150. The computer 90 includes a CPU 91, ROM 92, RAM 93, a storage device 94, an input interface 95, an output interface 96, and a communication interface 97.

The ROM 92 stores programs controlling operations of the computer 90. The ROM 92 stores programs necessary for causing the computer 90 to realize the processing described above. The RAM 93 functions as a memory region into which the programs stored in the ROM 92 are loaded.

The CPU 91 includes a processing circuit. The CPU 91 uses the RAM 93 as work memory and executes the programs stored in at least one of the ROM 92 or the storage device 94. When executing the programs, the CPU 91 executes various processing by controlling configurations via a system bus 98.

The storage device 94 stores data necessary for executing the programs and/or data obtained by executing the programs. The storage device 94 includes a solid state drive (SSD), etc. The storage device 94 may be used as the storage device 170.

The input interface (I/F) 95 can connect the computer 90 with an input device. The CPU 91 can read various data from the input device via the input I/F 95.

The output interface (I/F) 96 can connect the computer 90 and an output device. The CPU 91 can output data to the output device via the output I/F 96.

The communication interface (I/F) 97 can connect the computer 90 and a device outside the computer 90. For example, the communication I/F 97 connects a digital tool and the computer 90 by Bluetooth (registered trademark) communication.

The data processing performed by the processing device 150 may be performed by only one computer 90. A part of the data processing may be performed by a server or the like via the communication I/F 97.

Processing of various types of data described above may be recorded, as a program that can be executed by a computer, on a magnetic disk (examples of which include a flexible disk and a hard disk), an optical disk (examples of which include a CD-ROM, a CD-R, a CD-RW, a DVD-ROM, a DVD+R, and DVD+RW), a semiconductor memory, or another non-transitory computer-readable storage medium.

For example, information recorded on a recording medium can be read by a computer (or an embedded system). The recording medium can have any record format (storage format). For example, the computer reads a program from the recording medium and causes the CPU to execute instructions described in the program, on the basis of the program. The computer may obtain (or read) the program through a network.

Embodiments of the invention include the following features.

### Feature 1

A display device, configured to:
display a virtual object to overlap a real space;
acquire a position and a direction of the display device;
display a first virtual object indicating a permissible task range, the permissible task range being set using the position and the direction;
set a task position at a prescribed position for a fastening location of an article present in the real space;
determine whether or not the task position is within the permissible task range; and
output a first alert when the task position is outside the permissible task range.

### Feature 2

The display device according to feature 1, further configured to:
estimate whether or not a task has been performed for the fastening location; and
associate a record of the task with data of the fastening location when the task is estimated to have been performed.

### Feature 3

The display device according to feature 2, further configured to:
designate the fastening location on which the task is to be performed based on
   positions of a plurality of the fastening locations, the plurality of fastening locations being preregistered, and
   the records for the plurality of fastening locations; and
set the task position at the prescribed position for the designated fastening location.

### Feature 4

The display device according to feature 2, further configured to:
receive a torque value from a tool turning a screw; and
associate the torque value with the data of the fastening location as the record.

### Feature 5

The display device according to feature 4, further configured to:
determine whether or not the received torque value is not less than a prescribed torque value after the task;
determine whether or not a screw-tightening count at the fastening location matches a prescribed count after the task; and
output a second alert when the received torque value is less than the prescribed torque value, or when the screw-tightening count is less than the prescribed count.

### Feature 6

The display device according to any one of features 2 to 5, further configured to:
associate first data with the data of the fastening location when the task was performed while the task position was outside the permissible task range.

### Feature 7

The display device according to any one of features 2 to 6, further configured to:
display a second virtual object to correspond to the fastening location; and
estimate that the task is being performed at the fastening location based on contact between a prescribed object and the second virtual object.

### Feature 8

The display device according to any one of features 2 to 6, further configured to:
measure a position of a hand based on an image;
estimate a center position of a rotation of a tool turning a screw based on a plurality of the positions of the hand; and
estimate that the task is being performed at the fastening location based on the estimated center position.

### Feature 9

The display device according to any one of features 1 to 8, further configured to:
display a third virtual object including information of a task at the fastening location,
the information including at least one selected from a specified torque value necessary for screw-tightening at the fastening location, a torque value detected by a tool used in the screw-tightening, and a screw-tightening count at the fastening location.

### Feature 10

The display device according to any one of features 1 to 9, further configured to:
repeat the acquisition of the position and the direction of the display device and the setting of the permissible task range; and
stop the first alert when the task position is determined to be within the permissible task range after the output of the first alert.

### Feature 11

The display device according to any one of features 1 to 10, in which
a length of the permissible task range in the direction of the display device is greater than a length of the permissible task range in an orthogonal direction, and
the orthogonal direction is orthogonal to the direction.

### Feature 12

The display device according to any one of features 1 to 11, further configured to:
perform a registration mode to register the permissible task range;
in the registration mode, measure a plurality of positions of a hand, measure a position of the display device, and register the permissible task range based on distances from the position of the display device to the hand.

### Feature 13

The display device according to any one of features 1 to 11, in which
the permissible task range is set using the position and the direction of the display device and physique data of a wearer of the display device.

### Feature 14

An acquisition system, configured to:
acquire the physique data according to feature 13 to be referenced by the display device according to feature 13,
the physique data being acquired based on
   a distance between the position of the display device and a position of a hand of the wearer, and
   an image of a body of the wearer.

### Feature 15

A processing method,
the processing method being of a display device configured to display a virtual object to overlap a real space,
the processing method including:
causing the display device to
   acquire a position and a direction of the display device,
   display a first virtual object indicating a permissible task range, the permissible task range being set using the position and the direction,
   set a task position at a prescribed position for a fastening location of an article present in the real space,
   determine whether or not the task position is within the permissible task range, and
   output a first alert when the task position is outside the permissible task range.

### Feature 16

A program, when executed by the display device according to feature 15, causing the display device to perform the processing method according to feature 15.

### Feature 17

A non-transitory computer-readable storage medium configured to store the program according to feature 16.

According to the embodiments above, a display device, an acquisition system, a processing method, a program, and a storage medium are provided in which a task can be performed more safely.

In the specification, “or” shows that “at least one” of items listed in the sentence can be adopted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. Moreover, above-mentioned embodiments can be combined mutually and can be carried out.

What is claimed is:

1. A display device, configured to:
display a virtual object to overlap a real space;
acquire a position and a direction of the display device;
display a first virtual object indicating a permissible task range, the permissible task range being set using the position and the direction;
set a task position at a prescribed position for a fastening location of an article present in the real space;
determine whether or not the task position is within the permissible task range; and
output a first alert when the task position is outside the permissible task range.

2. The display device according to claim 1, further configured to:
estimate whether or not a task has been performed for the fastening location; and
associate a record of the task with data of the fastening location when the task is estimated to have been performed.

3. The display device according to claim 2, further configured to:
designate the fastening location on which the task is to be performed based on
positions of a plurality of the fastening locations, the plurality of fastening locations being preregistered, and
the records for the plurality of fastening locations; and
set the task position at the prescribed position for the designated fastening location.

4. The display device according to claim 2, further configured to:
receive a torque value from a tool turning a screw; and
associate the torque value with the data of the fastening location as the record.

5. The display device according to claim 4, further configured to:
determine whether or not the received torque value is not less than a prescribed torque value after the task;
determine whether or not a screw-tightening count at the fastening location matches a prescribed count after the task; and
output a second alert when the received torque value is less than the prescribed torque value, or when the screw-tightening count is less than the prescribed count.

6. The display device according to claim 2, further configured to:
associate first data with the data of the fastening location when the task was performed while the task position was outside the permissible task range.

7. The display device according to claim 2, further configured to:
display a second virtual object to correspond to the fastening location; and
estimate that the task is being performed at the fastening location based on contact between a prescribed object and the second virtual object.

8. The display device according to claim 2, further configured to:
measure a position of a hand based on an image;
estimate a center position of a rotation of a tool turning a screw based on a plurality of the positions of the hand; and
estimate that the task is being performed at the fastening location based on the estimated center position.

9. The display device according to claim 1, further configured to:
display a third virtual object including information of a task at the fastening location,
the information including at least one selected from a specified torque value necessary for screw-tightening at the fastening location, a torque value detected by a tool used in the screw-tightening, and a screw-tightening count at the fastening location.

10. The display device according to claim 1, further configured to:
repeat the acquisition of the position and the direction of the display device and the setting of the permissible task range; and
stop the first alert when the task position is determined to be within the permissible task range after the output of the first alert.

11. The display device according to claim 1, wherein
a length of the permissible task range in the direction of the display device is greater than a length of the permissible task range in an orthogonal direction, and
the orthogonal direction is orthogonal to the direction.

12. The display device according to claim 1, further configured to:
perform a registration mode to register the permissible task range;
in the registration mode, measure a plurality of positions of a hand, measure a position of the display device, and register the permissible task range based on distances from the position of the display device to the hand.

13. The display device according to claim 1, wherein
the permissible task range is set using the position and the direction of the display device and physique data of a wearer of the display device.

14. An acquisition system, configured to:
acquire the physique data according to claim 13 to be referenced by the display device according to claim 13,
the physique data being acquired based on
a distance between the position of the display device and a position of a hand of the wearer, and
an image of a body of the wearer.

15. A processing method,
the processing method being of a display device configured to display a virtual object to overlap a real space,
the processing method comprising:
causing the display device to
acquire a position and a direction of the display device,
display a first virtual object indicating a permissible task range, the permissible task range being set using the position and the direction,
set a task position at a prescribed position for a fastening location of an article present in the real space,
determine whether or not the task position is within the permissible task range, and
output a first alert when the task position is outside the permissible task range.

16. A non-transitory computer-readable storage medium configured to store a program,
the program, when executed by the display device according to claim 15, causing the display device to perform the processing method according to claim 15.
